(19) United States
(12) Patent Application Publication
(10) Pub. No.: US 2021/0178866 A1
(43) Pub. Date: Jun. 17, 2021

(54) Airbus Sunshade

(71) Applicant: Henry Biernacki, Las Vegas, NV (US)

(72) Inventor: Henry Biernacki, Las Vegas, NV (US)

(21) Appl. No.: 16/803,375

(22) Filed: Feb. 27, 2020

Related U.S. Application Data
(60) Provisional application No. 62/947,085, filed on Dec. 12, 2019.

(51) Int. Cl. B60J 3/02; B60J 1/20

(52) U.S. Cl. CPC B60J 3/0286; B60J 1/2011

(57) ABSTRACT

An airbus sunshade is shown and described. The airbus sunshade includes a first material configured to dim sunlight. An adhesive layer added to the sunshade, wherein the adhesive does not leave a residue. The first material of the sunshade is shaped to fit a side window of an airbus.

### CROSS REFERENCE TO RELATED APPLICATIONS

This application claims the benefit of U.S. Provisional Application No. 62/947,085 filed on Dec. 12, 2019. The above identified patent application is herein incorporated by reference in its entirety to provide continuity of disclosure.

### BACKGROUND OF THE INVENTION

The present invention relates to providing comfort and safety to pilots while flying an airbus. More particularly, the present invention provides a sunshade that is configured to fit within the windows of the cockpit of an airbus.

The sun can pose several issues when flying a plane. These issues are particularly prevalent in larger airbus type aircraft that fly at high altitudes allowing little protection from the sun's rays. The first issue is the intensity of the rays. The sun will often shine into a cockpit of an airbus. This can make it difficult for a pilot to see the instruments and properly fly the plane. These rays can also give the pilot a headache or cause the pilot o constantly squint to see inside the cockpit.

A second issue is the damage that can result from exposure to these sun rays. The rays can cause sunburn without protection. Further, prolonged exposure to the sun's rays can put pilots at a higher risk for sun related illnesses. One such illness is skin cancer. The sun even through windows can still produce radiation and thus cause skin cancer in pilots.

Consequently, there is a need in for an improvement in the art of flying an airbus in the sun. The present invention substantially diverges in design elements from the known art while at the same time solves a problem many people face when flying an airbus having the sun stream into the cockpit. In this regard the present invention substantially fulfills these needs.

### SUMMARY OF THE INVENTION

The present invention provides an airbus sunshade wherein the same can be utilized for providing convenience for the user when flying an airbus and needing to dim the suns bright and harmful rays. The airbus sunshade is comprised of a first material configured to dim sunlight. An adhesive layer applied to a rear surface of the first material, wherein the adhesive does not leave a residue. The first material of the sunshade is shaped to fit a side window of an airbus.

Another objective of the airbus sunshade is to have the first material be a mesh material.

Another objective of the airbus sunshade is to have the first material be a sun black out material.

Another objective of the airbus sunshade is to provide a trapezoid shape sunshade.

Another objective of the airbus sunshade is to have the dimensions of the trapezoid shape be are 13 inches along one side, 21 inches along a second side, 23 inches along a third side, and 27 and ½ inches along a fourth side.

Another objective of the airbus sunshade is to provide a hexagonal shape sunshade.

Another objective of the airbus sun shade is to have the dimensions of the hexagonal shape are 8 inches along a first side, 15 inches along a second side, 7 inches along a third side, 14 inches along a fourth side, 23 and ¼ inches along a fifth side, and 13 and ½ inches along a sixth side.

Another objective of the airbus sunshade is to have the sunshade be held to an airbus window using suction cups.

Another objective of the airbus sunshade is to have the sunshade be held in place with a frame that will frictionally secure the sunshade to the gaps of the airbus window.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of sunshades secured to cockpit windows.

FIG. 2 shows a cross-sectional view of an embodiment lithe airbus sunshade.

FIG. 3 shows a perspective view of an embodiment of the airbus sunshade.

FIG. 4 shows a top down view of an embodiment of the airbus sunshade.

FIG. 5 shows a perspective view of an embodiment of the airbus sunshade.

FIG. 6 shows a perspective view of an embodiment of the airbus sunshade.

### DETAILED DESCRIPTION OF THE INVENTION

Reference is made herein to the attached drawings. Like reference numerals are used throughout the drawings to depict like or similar elements of the airbus sunshade For the purposes of presenting a brief and clear description of the present invention, a preferred embodiment will be discussed as used for the airbus sun shade. The figures are intended for representative purposes only and should not be considered to be limiting in any respect.

Referring now to FIG. 1, there is shown a perspective view of an embodiment of sunshades secured to cock pit windows. In the shown embodiments there are two airbus sunshades 100 shown attached to windows of an airbus cockpit. It is further shown that the windows of an airbus have odd shapes and therefore require specific shapes to fit within the windows. The window of the airbus cock pit has a gap between the windowpane and a window support bar 101. In one embodiment these gaps can hold the airbus sunshade 100 in place.

In the shown embodiment the airbus sunshade 100 is made of a mesh material. This material will block out sun's rays while still allowing an individual to see through the airbus sunshade 100. In different embodiments the holes of the mesh are of different sizes to block or allow various amounts of sun to enter the cockpit. In another embodiment the airbus sunshade 100 is made from a black out material. The blackout material will not allow any of the sun's rays to pass into the cockpit thereby better protecting the pilot. A drawback to this material is that a pilot will not be able to see through the material.

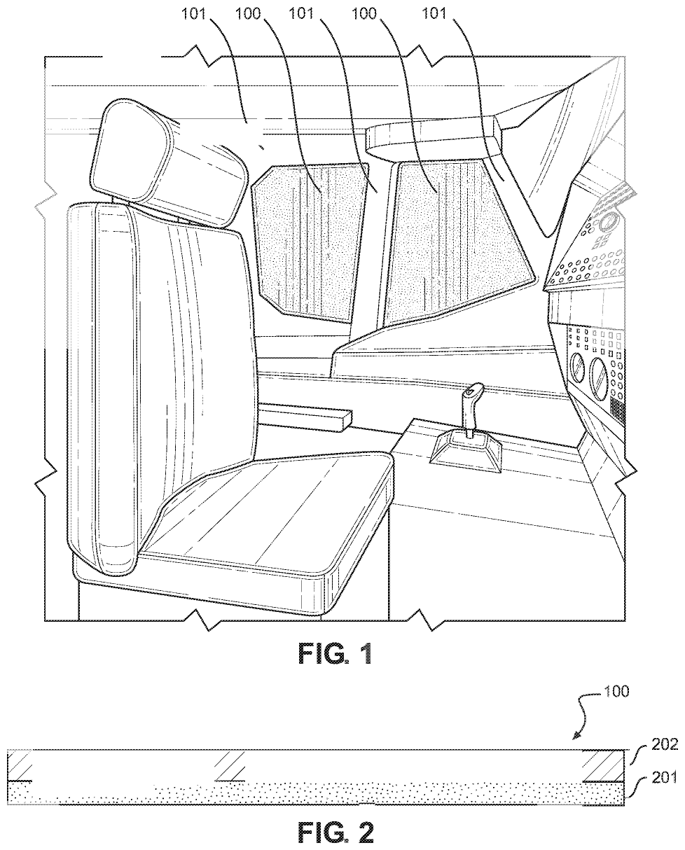

Referring now to FIG. 2, there is shown a cross-sectional view of an embodiment if the airbus sunshade. In one embodiment the airbus sunshade 100 is held onto the window of a cockpit using an adhesive 201. In one embodiment the airbus sunshade 100 has a first material layer 202. In one embodiment this first material layer 202 is a mesh material. In another embodiment this first material layer 202 is a black out material.

The first material layer is attached to an adhesive 201 on one side. This adhesive 201 will hold the first material layer 202 to a window. In one embodiment the adhesive 201 is a gel adhesive. In another embodiment the adhesive 201 is a tape. In yet another embodiment the adhesive 201 is a glue. In many embodiments the adhesive 201 is configured not to leave a residue on window when the airbus sunshade 100 is removed. This will allow a pilot to apply and remove the sunshade 100 without having to clean the window between every use.

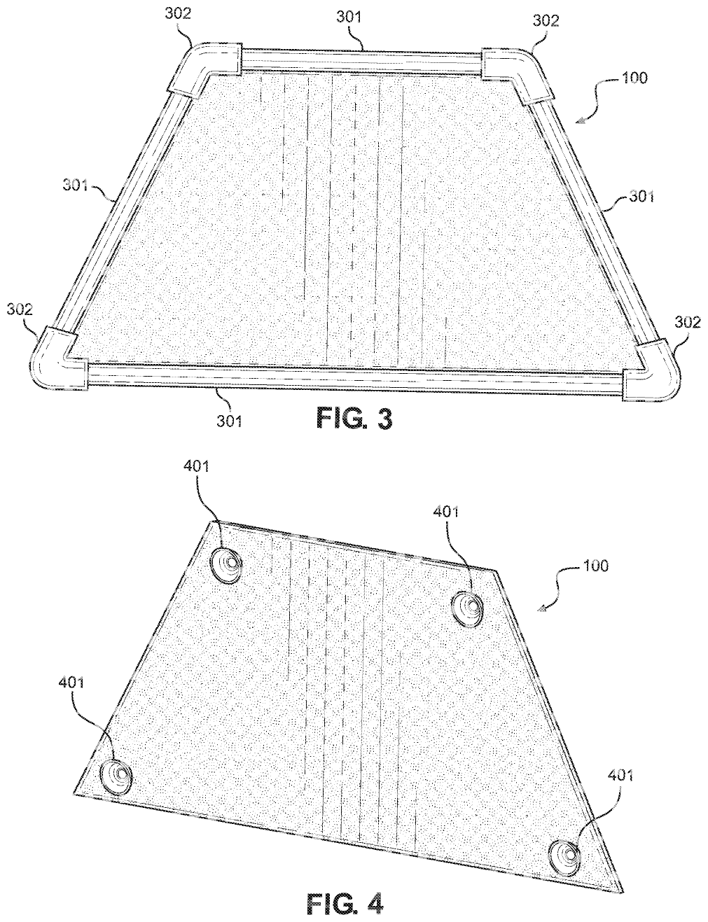

Referring now to FIG. 3, there is shown a perspective view of an embodiment of the airbus sunshade. In another embodiment the airbus sunshade 100 has an outer frame. In an embodiment with the outer frame, the outer frame will be configured to fit in the gap of the window as described in FIG. 1. This will securely hold the frame and the airbus sunshade 100 against the window blocking the sun's rays.

In the illustrated embodiment, the outer frame is comprised of a plurality of sides 301. In one embodiment the plurality of sides 301 are made from PVC pipes. In another embodiment the plurality of sides 301 are wooden. While the shown embodiment has four sides other embodiments may have more or less sides.

In one embodiment the plurality of sides 301 are held together within fasteners. In another embodiment the plurality of sides 301 are held together with connectors 302. In this embodiment each of the plurality of sides 301 has a first end and a second end. Each end is configured to fit within one portion of a connector 302. Another end from a different side of the plurality of sides 301 is then placed within a different portion of the connector 302 holding the sides together. The connectors 302 may be in various angles and shapes to provide different shapes of the airbus sunshade 100.

The airbus sunshade 100 is connected to the frame. In one embodiment the airbus sunshade 100 is connected to the frame by securing the perimeter of the airbus sunshade 100 to the frame. In another embodiment, a plurality of loops is added to the perimeter of the airbus sunshade 100, wherein the plurality of loops is configured to secure over the plurality of sides 301 of the frame. This will allow the frame to be removably connected to the airbus sunshade.

Referring now to FIG. 4, there is shown a top down view of an embodiment of the airbus sunshade. In a further embodiment the airbus sunshade 100 is secured to the window of a cockpit using connectors 401. In one embodiment the connectors are secured directly to the airbus sunshade 100. In another embodiment the connectors are secured to the frame described in FIG. 3. The connectors 401 are configured to secure the airbus sunshade 100 to the window. In the illustrated embodiment the connectors 401 are suction cups. In another embodiment the connectors 401 are hooks. In yet a further embodiment the connectors 401 are isolated adhesive pads. In this embodiment the adhesive will be the same as described in FIG. 2.

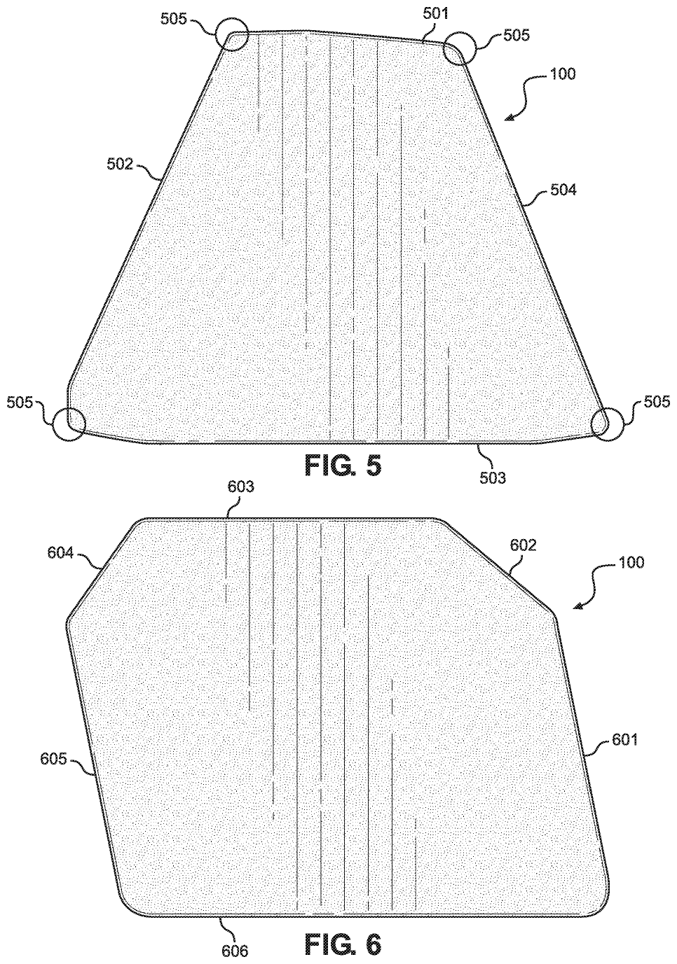

Referring now to FIG. 5, there is shown a perspective view of an embodiment of the airbus sunshade and dimensions. In several embodiments the airbus sunshade 100 is proportioned to fit within a specific window of an airbus cockpit. In several embodiments the shape of the airbus sunshade 100 is a trapezoidal shape. In one embodiment the shape has rounded corners 505. This will better allow the airbus sunshade 100 to fit within the window of the cockpit.

For an embodiment where the airbus sunshade 100 is proportioned to fit in an airbus model 318, 319, 320, or 21 the proportions may be as follows. A first side 501 of the airbus sunshade 100 will have a measurement of 13 inches. A second side 502 of the airbus sunshade 100 will have a measurement of 21 inches. A third side 503 of the airbus sunshade 100 will have a measurement of 27.5 inches. A fourth side 504 of the airbus sunshade 100 will have a measurement of 23 inches. Other embodiments meant to fit in different airbus models may have different proportions.

Referring now to FIG. 6, there is shown a perspective view of an embodiment of the airbus sunshade and dimensions. In several embodiments the airbus sunshade 100 is proportioned to fit within a specific window of an airbus cockpit. In several embodiments the shape of the airbus sunshade 100 is a hexagonal shape. In one embodiment the shape has a rounded corner. This will better allow the airbus sunshade 100 to fit within the window of the cockpit.

For an embodiment where the airbus sunshade 100 is proportioned to fit in an airbus model 318, 319, 320, or 321 the proportions may be as follows. A first side 601 of the airbus sunshade 100 will have a measurement of 13.5 inches. A second side 602 of the airbus sunshade 100 will have a measurement of 8 inches. A third side 603 of the airbus sunshade 100 will have a measurement of 15 inches. A fourth side 604 of the airbus sunshade 100 will have a measurement of 7 inches. A fifth side 605 of the airbus sunshade 100 will have a measurement of 14 inches. A sixth side 606 of the airbus sunshade 100 will have a measurement of 23.25 inches. Other embodiments meant to fit in different airbus models may have different proportions.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.
1) An airbus sunshade, the sunshade comprising:
a first material configured to dim sunlight;
an adhesive layer applied to a rear surface of the first material, wherein the adhesive does not leave a residue;
the sunshade is shaped to fit a side window of an airbus.

2) The sunshade of claim 1, wherein the first material is a mesh material.

3) The sunshade of claim 1, wherein the first material is a sun black out material.

4) The sunshade of claim 1, wherein the sunshade is a trapezoid.

5) The sunshade of claim 4, wherein the dimensions of the trapezoid are 13 inches along one side, 21 inches along a second side, 23 inches along a third side, and 27 and ½ inches along a fourth side.

6) The sunshade of claim 1, wherein the sunshade is hexagonal.

7) The sun shade of claim 6, wherein the dimensions of the shape are 8 inches along a first side, 15 inches along a second side, 7 inches along a third side, 14 inches along a fourth side, 23 and ¼ inches along a fifth side, and 13 and ½ inches along a sixth side.

8) An airbus sunshade, the sunshade comprising:
a first material configured to dim sunlight;
the first material is connected to a frame;
wherein the frame is configured to fit about the perimeter of the first material;
the sunshade is shaped to fit a side window of an airbus.

9) The sunshade of claim 8, wherein the first material is a mesh material.

10) The sunshade of claim 8, wherein the first material is a sun black out material.

11) The sunshade of claim 8, wherein the sunshade is a trapezoid.

12) The sunshade of claim 11, wherein the dimensions of the trapezoid are 13 inches along one side, 21 inches along a second side, 23 inches along a third side, and 27 and ⅕ inches along a fourth side.

13) The sunshade of claim 8, wherein the sunshade is hexagonal.

14) The sun shade of claim 13, wherein the dimensions of the shape are 8 inches along a first side, 15 inches along a second side, 7 inches along a third side, 14 inches along a fourth side, 23 and ¼ inches along a fifth side and 13 and ½ inches along a sixth side.

15) An airbus sunshade, the sunshade comprising:
a first material configured to dim sunlight;
a plurality of suction cups attached to the sunshade, wherein the suction cups hold the sunshade to a window;
the sunshade is shaped to fit a side window of an airbus.

16) The sunshade of claim 15, wherein the first material is a mesh material.

17) The sunshade of claim 15, wherein the first material is a sun black out material.

18) The sunshade of claim 15, wherein the sunshade is a trapezoid.

19) The sunshade of claim 18, wherein the dimensions of the trapezoid are 13 inches along one side, 21 inches along a second side, 23 inches along a third side, and 27 and ⅕ inches along a fourth side.

20) The sunshade of claim 15, wherein the sunshade is hexagonal.
